(19) United States
(12) Patent Application Publication
(10) Pub. No.: US 2003/0036823 A1
(43) Pub. Date: Feb. 20, 2003

(54) Method and system for a vehicle monitoring and control system

(76) Inventor: A. Pascal Mahvi, Novelty, OH (US)

Correspondence Address: SQUIRE, SANDERS & DEMPSEY L.L.P., 801 S. Figueroa St., 14th FI., Los Angeles, CA, 90017-5554, US

(21) Appl. No.: 09/931,698

(22) Filed: Aug. 15, 2001

(51) Int. Cl. G06F 19/00

(52) U.S. Cl. 701/1; 701/29; 340/426

(57) ABSTRACT

This invention relates generally to vehicle monitoring and control systems and more particularly to imposing various conditions on the operation of a vehicle. The conditions may involve, but are not limited to, allowable areas of travel, acceptable times and dates, permissible occupant load, permissible vehicle speeds, and operator alcohol consumption. Various constraining events may be initiated if any and/or all of the conditions are not satisfied. For example, if the operator of a vehicle drives outside an “allowable” area, the vehicle may be disabled.

### BACKGROUND OF THE INVENTION

1. Field of the Invention

This invention relates generally to vehicle monitoring and control systems and, more particularly, to a system for imposing various conditions on the operation of a vehicle. The conditions may involve, but are not limited to, allowable areas of travel, acceptable times and dates, permissible occupant loads, operator alcohol consumption, and maximum vehicle speed.

2. General Background and State of the Art

Vehicle computer technology, allowing vehicles such as automobiles and boats to be controlled by computers, has undergone rapid and sophisticated development. Computers in vehicles control the engine, advanced diagnostics, comfort, convenience, and safety features, transmission management, global positioning system (“GPS”), and fuel economy systems. These control functions have fostered the need for sophisticated control systems and vehicles which contain many microprocessors and control modules. The design advantage of a computer controlled vehicle is that a central computer module, or a plurality of interconnected computer modules, can regulate the various electronic and electro-mechanical systems of the vehicle.

Computer controlled vehicles may contain many different control modules to operate and maintain the different systems of the vehicle. For example, the engine control unit, or ECU, manages sophisticated control schemes to regulate the air/fuel mixture to the engine. The ECU may use closed control loops to manage emissions and the fuel economy of the vehicle. Examples of other control modules include, but are not limited to, the airbag control module, body control module, cruise control module, instrument panel control module, climate control module, ABS control module, transmission control module, power control module, and GPS control module.

The various control modules operate on a central communications bus, using a particular vehicle communications protocol. Communication chips are also implemented to allow the various control modules to communicate with each other on the communications bus. All of the different modules communicate with each other by sending and receiving data to and from the communications bus, respectively.

Despite the elaborate controls that vehicle computer modules can maintain over a vehicle, a typical problem vehicle owners encounter is not having control over their vehicle when the vehicle is in use by another person. Furthermore, if a vehicle owner intends the vehicle to be used in a particular manner, there is little that can be done to remotely regulate control of the vehicle. For example, although the ignition control of a vehicle may be a highly sophisticated computer which regulates starting the vehicle, a vehicle owner cannot presently use the module to prevent ignition during certain times of the day. Therefore, there is still a need for a vehicle monitoring and control system that communicates with and can instruct the various modules of the vehicle to allow the vehicle owner to control the vehicle in a precise manner.

### INVENTION SUMMARY

One of the features of the present invention is to provide the owner with a control module (hereinafter the “Owner Control Module”) which is adapted to operate on the communications bus of a vehicle. The Owner Control Module is a computer which can control the other modules and/or send and receive data to and from the other modules. An input/output interface may be attached to the Owner Control Module which allows the vehicle owner to maintain desired settings. For example, the vehicle owner can specify to the Owner Control Module via the input/output interface to prohibit the vehicle from exceeding posted speed limits. The GPS Control Module may be utilized to ascertain the posted speed limit by corresponding the vehicle location to a location on a pre-stored map which contains the speed limits for particular roads. The Owner Control Module would then communicate with the GPS Control Module and the Engine Control Unit such that if the vehicle exceeds a posted speed limit, the Engine Control Unit would cut and/or limit fuel to the vehicle.

Another feature of the present invention is to provide a system and method of controlling a vehicle that allows a vehicle owner to control the area in which another operator may operate the vehicle and/or control the time and date when another person may operate the vehicle. In this exemplary embodiment, a GPS Control Module communicates the current position of the vehicle to the Owner Control Module. Also, a Time and Date Module may communicate the current time and date to the Owner Control Module. The Owner Control Module then instructs the Engine Control Unit to cut off and/or limit fuel to the vehicle if the current position reported by the GPS Control Module is not within a predetermined geographic area and/or the current time and date reported by the Time and Date Module are not within a predetermined time setting.

Another feature of the present invention is to provide a system and method of controlling a vehicle that allows a vehicle owner to prevent ignition of the vehicle if the number of passengers exceeds a preset maximum and/or the time and the date of an attempted vehicle ignition is outside a predetermined range. In this exemplary embodiment, an Occupant Sensor Module communicates the number of passengers in the vehicle to the Owner Control Module. At the time of an attempted ignition, the Time and Date Module communicates the current time and date to the Owner Control Module. The Owner Control Module then communicates with the Ignition Control Module, which may be an independent control module or part of the Engine Control Unit, for example. The Owner Control Module disables the Ignition Control Module to prevent ignition if the reported number of passengers is not under a predetermined maximum and/or the reported time and date are not within a designated range.

Another feature of the present invention is to provide a system and method of controlling a vehicle that allows a vehicle owner to control the acceptable volume of a vehicle audio system. In this exemplary embodiment, the owner can prevent a vehicle operator from setting the volume of the audio system in the vehicle above a predetermined setting. Furthermore, the noise level of the passengers may be monitored and the vehicle may be disabled if the occupant noise level exceeds a predetermined maximum allowable level.

Yet another feature of the present invention is to provide a system and method of controlling a vehicle that allows a vehicle owner to prohibit vehicle operation by persons who are under the influence of alcohol. In this exemplary embodiment, a breath or blood alcohol measuring device is provided to communicate the detected level of alcohol in an operator to the Owner Control Module. The Owner Control Module then instructs the Engine Control Unit to disable the vehicle if the detected level of alcohol is not under an acceptable maximum.

Still another feature of the present invention is to provide a system and method of controlling a vehicle that allows a vehicle owner to control the speed at which a person may operate the vehicle. In this exemplary embodiment, a Speed Control Module communicates the current speed of the vehicle to the Owner Control Module. A GPS Control Module may communicate the current position of the vehicle to the Owner Control Module which can then access its data bank to determine speed limits for the street on which the vehicle is traveling. The Owner Control Module then communicates with the fuel control module, which may be an independent control module or part of the engine control module, for example. The Owner Control Module instructs the fuel control module to limit fuel to the vehicle if the current speed reported by the GPS Module is not within a predetermined range and/or under the speed limit ascertained by the GPS control module.

Many modifications, variations, and combinations of the methods and systems of controlling a vehicle are possible in light of the embodiments described briefly above. The description above and many other features and attendant advantages of the present invention will become apparent from a consideration of the following detailed description when considered in conjunction with the accompanying drawings.

### BRIEF DESCRIPTION OF THE DRAWINGS

A detailed description with regard to the embodiments in accordance with the present invention will be made with reference to the accompanying drawings.

FIG. 1 shows an exemplary system diagram of a vehicle control system;

FIG. 2 shows an exemplary system diagram of a GPS module;

FIG. 3 shows an exemplary system diagram of an external communications module;

FIG. 4 shows an exemplary system diagram of a speed detector module;

FIG. 5 shows an exemplary system diagram of a breath alcohol module;

FIG. 6 illustrates a method diagram where a vehicle is controlled within a permissible area of travel;

FIG. 7 illustrates a method diagram where a vehicle is controlled within a permissible area of travel and a warning may be issued to a vehicle operator;

FIG. 8 illustrates a method diagram where a vehicle ignition is controlled to limit ignition within a permissible range of times and/or dates;

FIG. 9 illustrates a method diagram where a vehicle ignition is controlled based upon a permissible number of passengers;

FIG. 10 illustrates a method diagram where a vehicle ignition is controlled based upon a permissible range of times and/or dates;

FIG. 11 illustrates a method diagram where a vehicle is controlled based upon a permissible maximum speed;

FIG. 12 illustrates a method diagram where a vehicle is controlled based upon a permissible operator alcohol consumption level;

FIG. 13 shows an exemplary system diagram which allows control of one or more of the methods of FIGS. 2-8;

FIG. 14 illustrates a method diagram where the audio level in a vehicle is controlled; and

FIG. 15 illustrates a method diagram where a vehicle is controlled based upon a permissible occupant noise level.

### DETAILED DESCRIPTION OF THE PREFERRED EMBODIMENTS

The following figures and description should not be taken in a limiting sense but is provided for the purpose of illustrating and describing the principles of the invention. The section titles and overall organization of the detailed description are for purposes of convenience only and are not intended to limit the present invention.

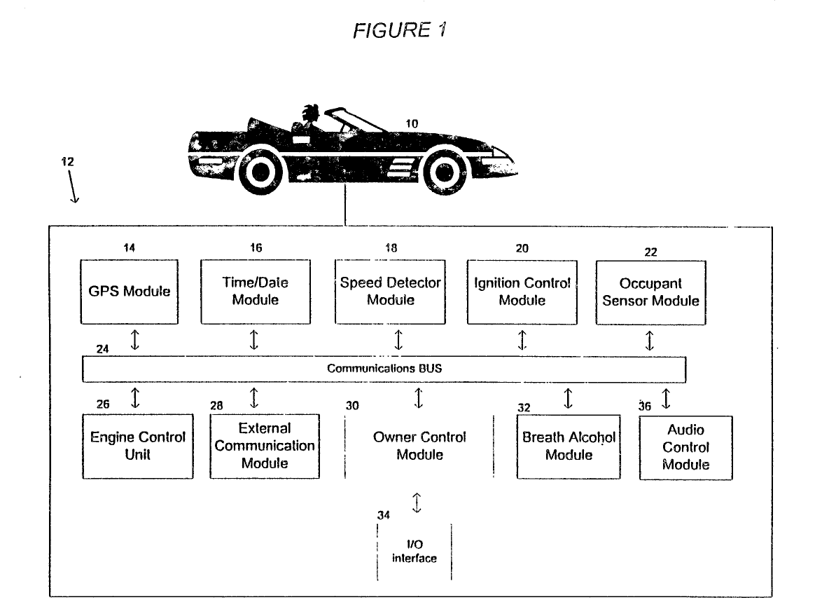

FIG. 1 depicts a vehicle 10 and an exemplary system diagram of the vehicle's control system 12. The control system 12 comprises a number of interconnected or even combined control modules for processing signals and controlling various systems within the vehicle 10. In the present embodiment, each control module may contain a processor and/or a memory unit and a means to communicate with the other modules via the communications bus. For example, the means to communicate may be a communications chip and/or a network interface card. A myriad of different communications standards, means, and/or protocols known to one skilled in the art may be used in the present invention, such as for example, the CAN (controller-area networking) standard. This communication standard allows for communication speeds of up to 500 kilobits per second (kbps) and is realized using two communications wires. High speed communications is desired because some of the control modules may communicate data onto the bus hundreds of times per second.

In the present embodiment, the computer modules may include a Time/Date Module 16, a Speed Detector Module 18, an Ignition Control Module 20, an Occupant Sensor Module 22, a Global Positioning System (GPS) Module 14, an Engine Control Unit 26, an External Communication Module 28, and or a Breath-alcohol Module 32. All of the modules may communicate with one another via a communications bus 24 and any one module may depend in part on any other module for proper operation. It is to be understood that the disclosed descriptions of vehicle modules are for exemplary purposes only. Any combinations of control modules may be used and the precise nomenclature is not intended to limit the present invention. For example, although an Engine Control Unit 26 is shown, which in this exemplary embodiment is intended to control the fuel system, it is within the scope of the present invention to have a separate Fuel Control Module. As another example, the Ignition Control Module 20 may be contained within the Engine Control Unit 26, or any other module. Similar combinations apply to all of the modules. The Owner Control module 30 and/or the Input/Output interface 34 may be contained within any of the other modules.

The Owner Control Module 30 of the present invention is communicatively coupled to the communications bus 24 and allows the owner to program and control the various control modules through the Input/Output interface 34. The term “owner” simply denotes the person who has access to the Owner Control Module. The Owner Control Module may be protected by a password and/or any type of encryption and/or computer security known to one skilled in the art.

The Ignition Control Module 20 is responsible for starting the car when a vehicle operator performs an ignition starting event. An ignition starting event may be inserting the ignition key into to the ignition key hole and turning it and/or pressing an ignition start button utilized in certain types of automobiles.

The Engine Control Unit (ECU) 26 uses an equation and a large number of lookup tables to determine the appropriate fuel equation for various operating conditions. Oxygen sensors (not shown) monitor the amount of oxygen in the exhaust, and the Engine Control Unit 26 uses this information to adjust the air-to-fuel ratio in real-time. The ECU also controls spark timing and other critical components of engine management. The Owner Control Module 30 can instruct the Engine Control Unit 26 to shutoff fuel to the vehicle, disable the vehicle, or limit fuel to the vehicle to maintain a desired speed.

The Audio Control Module 36 is responsible for controlling the audio system(s) of a vehicle. The Audio Control Module may integrated into a component of a vehicle audio system. For example, the Audio Control Module may be a processor located inside the vehicle audio amplifier. Alternatively, the Audio Control Module 36 may be a separate component which can communicate with the vehicle audio system(s).

The Time and Date Module 16 of the present invention, reports the current time and date and may verify the accuracy or obtain the time and date from an external clock signal received through the External Communication Module 28 and/or the GPS Module 14.

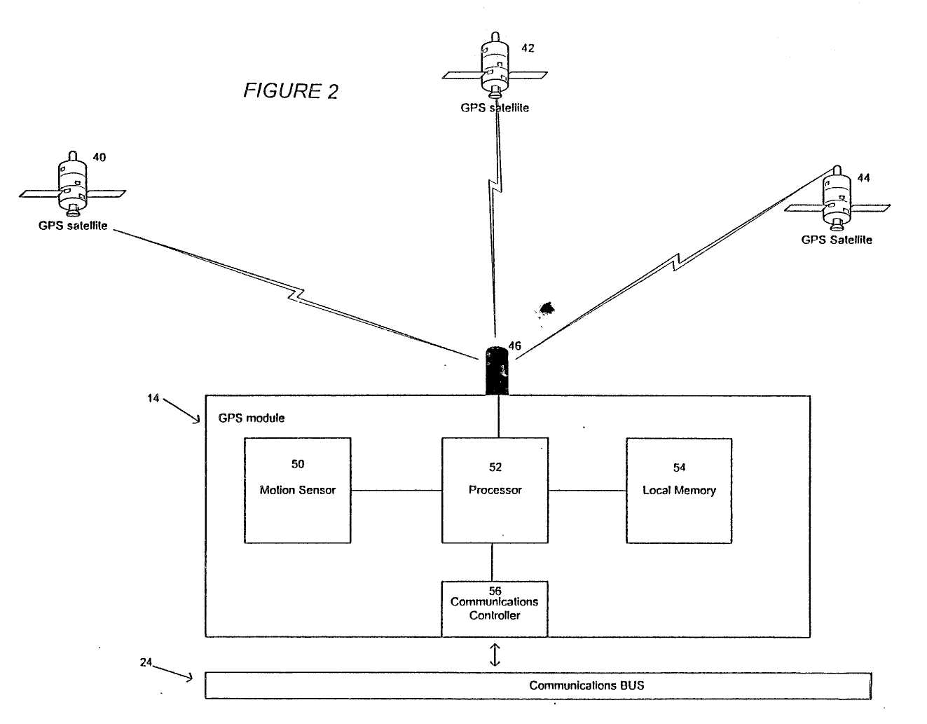

FIG. 2 shows the exemplary Global Positioning System (GPS) Module 14, of the present invention, which in accordance with the one embodiment picks up the transmissions of GPS satellites 40, 42, 44 and combines the information in those transmissions with information in an electronic map stored electronically in any of the modules. The map may also be shared in the local memory 54. The GPS Module 14 further combines the information from the satellite transmission with information obtained by a mechanical motion sensor 50 such as a gyroscope unit (not shown). The gyroscope unit is used to supplement the GPS Module 14 if, for example, the GPS Module 14 is in a tunnel and cannot detect a signal from the satellites. The gyroscope unit calculates the vehicles angular speed along the path of motion. Errors typical of gyroscopes, such as scale factor errors and bias drift, are taken into consideration. The output of the gyroscope unit is used by the GPS Module 14 to accurately report position. The processor 52 in the GPS Module 14 then mathematically determines the receiver's position on Earth and communicates this information to any of the other modules on the communication bus 24, via the communications controller 56. The basic information the GPS Module 14 provides is the latitude, longitude and altitude (or some similar measurement) of its current position.

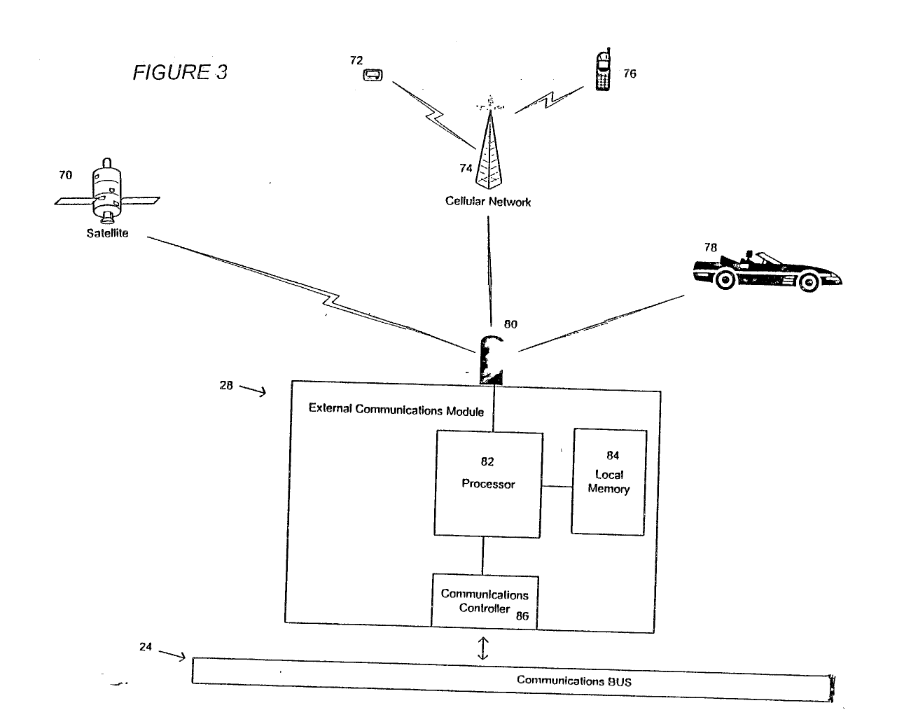

FIG. 3 shows the External Communication Module 28 of the present invention which controls communications between the vehicle 10 and other entities such as satellites 70, cellular network stations 74, and/or other vehicles 78. The External Communication Module 28 may include an electromagnetic transmitter and receiver 80 in order to send and receive data. In one embodiment, the External Communication Module 28 may be a cellular telephone transmitter/receiver which communications to and from typical cellular network stations 74. Alternatively, the External Communication Module 28 may be a system designed to communicate directly with a satellite 70. In another embodiment, the External Communication Module 28 is designed to communicate directly to a low earth orbit satellite (not shown) optimized for global network (internet) communications.

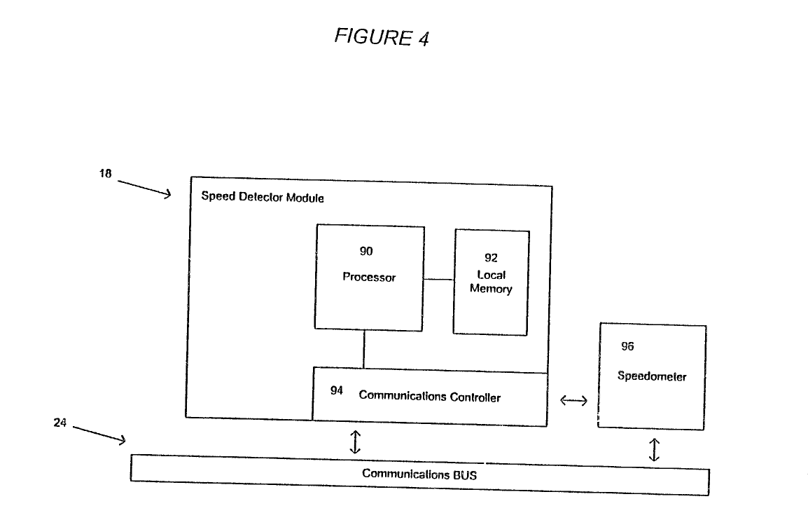

FIG. 4 shows the Speed Detector Module 18 of the present invention, which reports the current speed of the vehicle. In one embodiment, the Speed Detector Module 18 may be communicatively coupled to the speedometer 96 of the vehicle, via the communications bus 24 or directly. The Speed Detector Module 18 may report the speedometer 96 reading when requested by another module or may send the current speed to the communication bus 24 periodically in equal time intervals. In an alternative embodiment, the Speed Detector Module 18 uses successive locations obtained through the GPS Module 14 and time information from the Time/Date Module or the GPS Module in order to calculate the speed. An external computer can also calculate the speed of the vehicle in this manner through information transmitted and received through the External Communication Module 28.

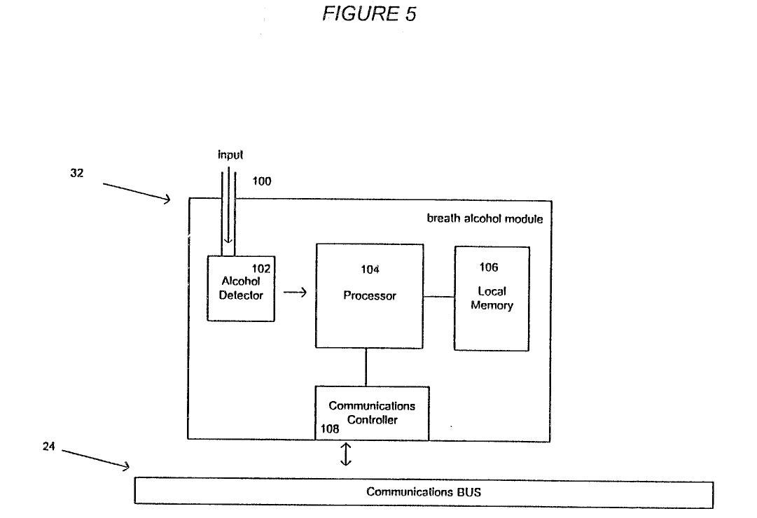

FIG. 5 shows the Breath Alcohol Module 32 which contains an input mechanism 100 which tests the operators breath to detect whether the operator has been consuming alcohol 102. The Breath Alcohol Module 32 may contain an algorithm which predicts the Blood Alcohol Content (BAC) based upon a breath analysis.

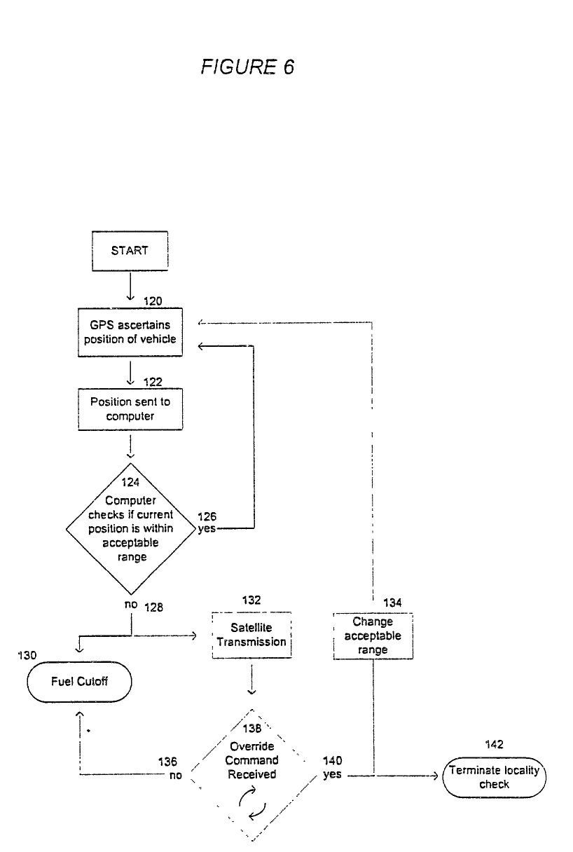

FIG. 6 illustrates, by way of example, an exemplary method of the present invention where the Owner Control Module 30 executes a program which precludes an operator from driving outside a predetermined area. The program may be implemented as a software algorithm utilizing the Owner Control Module's 30 microprocessor and local memory. First, the owner inputs via the Input/Output Interface 34, the permissible driving areas. In one exemplary embodiment, the owner inputs a central location and then specifies a maximum allowable radius around that central location. In an alternative embodiment, the owner may draw a boundary which is superimposed onto a map. The Input/Output Interface may be a port which the operator can connect to via a network and a client computer. Alternatively, the Input/Output Interface may be a computer with an input and an output device and a display which the owner can use to program the Owner Control Module 30. An input device could be a floppy diskette or a smart-card or a memory stick. Any device easily programmable by any PC is preferred.

After a predetermined permissible area of travel is specified, the algorithm begins with the Global Positioning System Module 14 ascertaining the current position of the vehicle 120. The current position is then sent 122 to the Owner Control Module 30 via the communication bus 24. The Owner Control Module 30 checks if the reported position is within the owner defined acceptable areas of travel 124. If the reported position is within the acceptable areas of travel 126, the algorithm starts over again with ascertaining the position of the vehicle 120. If however, the reported position is outside the acceptable areas of travel 128, the Owner Control Module 30 may instruct the Engine Control Unit 26 to cutoff fuel 130 to the engine. In an alternative embodiment, the Owner Control Module 30 instructs the External Communication Module 28 to send a message 132 to the owner that the current operator has driven outside the acceptable areas. The communication made to the owner may be a phone call with an automated message, a pager and/or an e-mail message or any form of remote communications known to one skilled in the art. The External Communication 28 module then waits 138 for a predetermined time for a response by the owner. If the owner does not respond in the allotted time 136, which is tracked by the Owner Control Module 30, the fuel is limited or even shut off.

On the other hand, if the owner receives the message from the vehicle that the current operator has traveled outside the permissible area, he/she may issue an override command 140 which is received by the External Communication Module 28 and then sent to the Owner Control Module 30. The override command 140 may simply be an instruction to terminate the algorithm 142 or the owner may specify a new acceptable driving range 134. The owner can specify the desired override option via the telephone or a 2 way pager, or the internet or any other remote communications method known to one skilled in the art. For example, a particular number on a touch tone phone may cause a complete termination of the program 142 or an increase in the allowable radius 134. As a further example, the owner can send an electronic file to the External Communication Module 28 of the new permissible map.

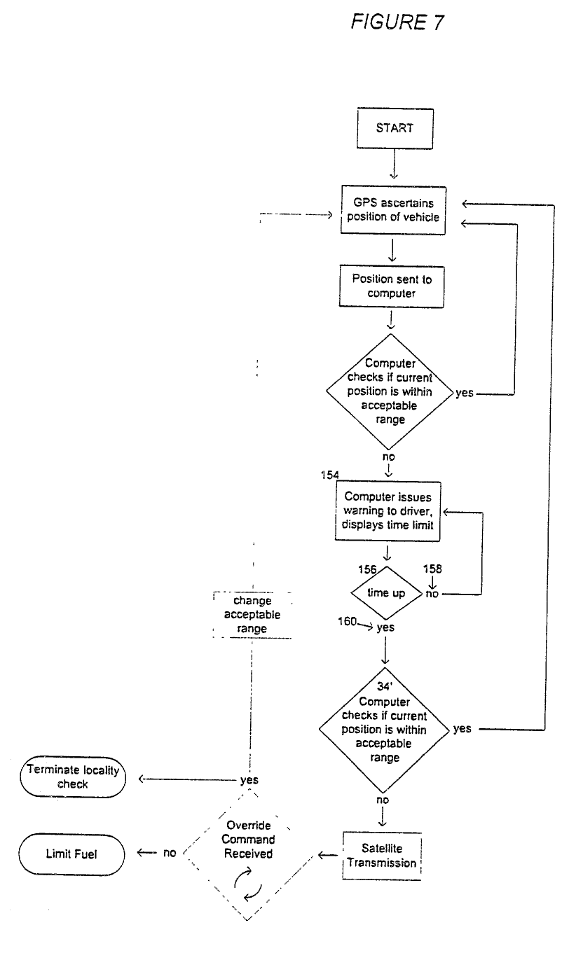

FIG. 7 illustrates the method in FIG. 6 with an added warning feature. If the Owner Control Module 30 determines the vehicle is not within the acceptable driving range the Owner Control Module 30 issues a warning 154 to the operator, and initiates a time countdown. The warning may be issued through a module which controls the instrument panel within the vehicle and the timer information may originate from the Time/Date Module 16 or from an internal clock within the Owner Control Module 30 or any other module. The warning, which may be a flashing signal, repeats for the duration of the time countdown 156, 158, 160. The operator of the vehicle can use the time before the time expires to relocate the vehicle to a position within the acceptable range. When the timer expires 160, the algorithm continues as in FIG. 6 step 124.

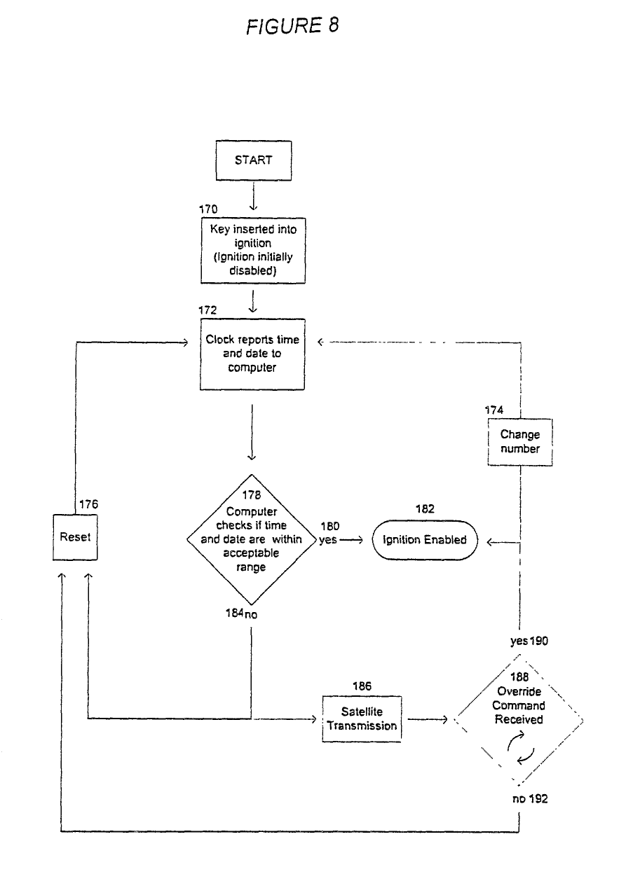

FIG. 8 illustrates, by way of example, an exemplary program the Owner Control Module 30 executes which precludes a operator from starting the vehicle if the time and/or the date at which the operator initiates a starting event is not within a predetermined range of times and dates. A starting event may be any action which is intended to start the vehicle, such as inserting the ignition key or pushing a start button. The operator inputs via the Input/Output interface 34, the permissible times and dates for driving the vehicle. In one exemplary embodiment, every time and date would default as an “impermissible” time and date and the operator would have to explicitly allow certain times and dates. In an alternative embodiment, every time and date would default as a “permissible” time and date and the operator would have to explicitly disallow certain times and dates.

After a predetermined range of permissible times and dates are specified, the algorithm begins after a operator inserts an ignition key into the ignition key slot of a vehicle 170. In the present embodiment, the ignition to the vehicle is initially disabled, and requires specific activation. In an alternative embodiment, the ignition to the vehicle is initially enabled and requires specific deactivation. The Time and Date Module 16 then reports the current time and date 172 to the Owner Control Module 30 via the Communication bus 24. In an alternative embodiment, the Owner Control Module 30 instructs the External Communication Module 28 to send a message 186 to the owner of the vehicle that the current operator has attempted to start the vehicle at an impermissible time and/or date. The communication made to the owner may be a phone call with an automated message and or an e-mail message or a pager message and/or any form of remote communications known to one skilled in the art. The External Communication Module 28 then waits 188 for a predetermined time for a response by the owner. If the owner does not respond in the allotted time 192, which may be tracked by the Owner Control Module 30 or any other module, the ignition remains disabled and the operator may repeat attempting the ignition process.

The Owner Control Module 30 checks if the time and date is within the owner defined range of acceptable times and dates 178. If the reported time and date is within the acceptable range 180, the algorithm enables the ignition 182. If however, the reported time and date does not fall within the permissible range 184, the operator may repeat attempting the ignition process by first resetting the algorithm 176. By way of example, the reset process may involve reinserting the key and/or pressing a reset button.

Alternatively, if the owner receives the message from the vehicle that the current operator has attempted to start the vehicle at an impermissible time and date, he/she may issue an override command 190 which is received by the External Communication Module 28 and then sent to the Owner Control Module 20. The override command may simply be an instruction to terminate the time and date checking 182 or the owner may specify new acceptable times and dates 174.

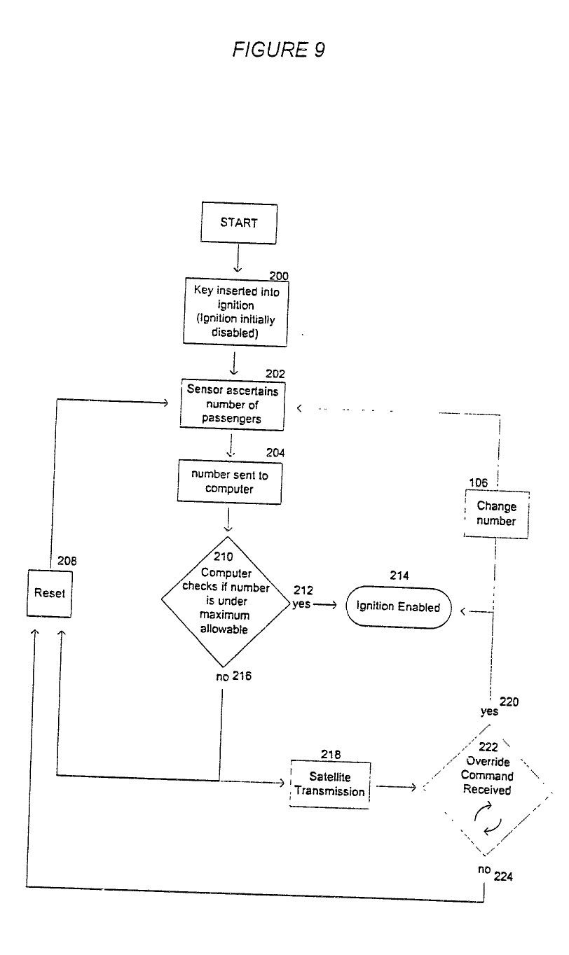

FIG. 9 illustrates, by way of example, an exemplary program the Owner Control Module 30 executes which precludes a operator from starting the vehicle if the number of passengers in the vehicle exceeds a predetermined maximum allowable number. In one embodiment, the operator inputs via the Input/Output interface 34, the maximum number of allowed passengers. In an alternative embodiment, the maximum number of allowed passengers is stored inside a module which verifies if an occupant is wearing a seatbelt.

After a predetermined maximum number of passengers is specified, the algorithm begins after a operator inserts an ignition key into the ignition key slot of a vehicle 200. In the present embodiment, the ignition to the vehicle is disabled, and requires specific activation. In an alternative embodiment, the ignition to the vehicle is initially enabled and requires specific deactivation. The Occupant Sensor Module 22 ascertains the number of passengers 202 and then reports the number of passengers 204 to the Owner Control Module 30 via the communications bus 24. The Occupant Sensor Module 32 may take on a variety of forms known to one skilled in the art and it is within the scope of the present invention to ascertain the number of passengers via pressure sensors for each seat in the vehicle and/or infrared thermal sensors, etc. In one embodiment, a module which verifies if an occupant is wearing a seat belt may also control pressure sensors in each seat.

The Owner Control Module 30 then checks if the number of passengers is less than or equal to the maximum allowable number of passengers 210. If the reported number of passengers is less than or equal to the limit 212, the algorithm enables the ignition 214. If, however, the reported number of passengers exceeds the maximum allowable number 216, the operator may repeat attempting the ignition process by first resetting the algorithm 208.

In an alternative embodiment, the Owner Control Module 30 instructs the External Communication Module 28 to send a message 218 to the owner of the vehicle that the current operator has attempted to start the vehicle with an impermissible number of passengers. The External Communication Module 28 then waits 222 for a predetermined time for a response by the owner. If the owner does not respond in the allotted time 224, which is tracked by the Owner Control Module 30 or any other module, the ignition remains disabled and the operator may repeat attempting the ignition process 208.

Alternatively, if the owner receives the message from the vehicle that the current operator has attempted to start the vehicle with an impermissible number of passengers, he/she may issue an override command 220 which is received by the External Communication Module 28 and then sent to the Owner Control Module 30. The override command may simply be an instruction to terminate the algorithm and enable the ignition 214 or the owner may specify a new acceptable maximum 206.

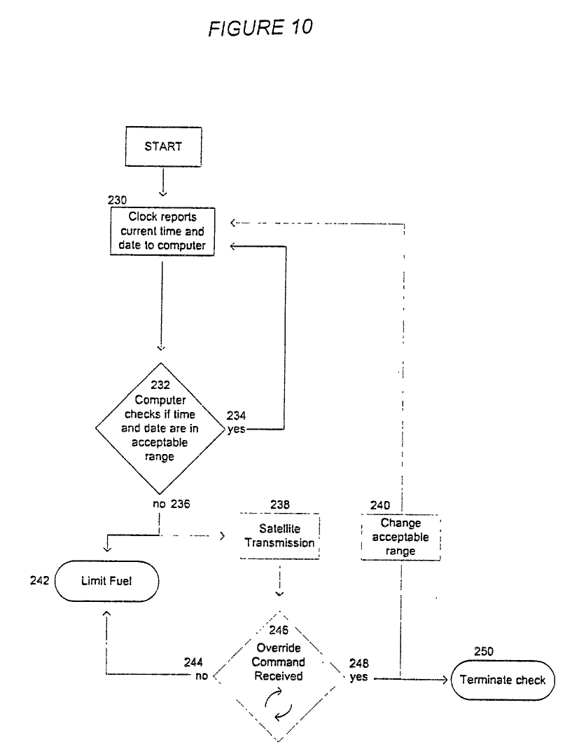

FIG. 10 illustrates, by way of example, an exemplary program the Owner Control Module 30 executes which precludes a operator from driving the vehicle if the time and or date at which the is in operation is not within a predetermined range of times and dates. The owner inputs via the Input/Output interface 34, the permissible times and dates for driving the vehicle.

After the predetermined permissible times and dates are specified, the algorithm begins with the Time and Date Module ascertaining the current time and date 230. This information is then sent to the Owner Control Module 30 via the Communications bus 24. The Owner Control Module 30 checks if the reported time and date is within the owner defined acceptable times and dates 232. If the reported time and date is within the acceptable range of times and dates 234, the algorithm starts over again with ascertaining the current time and date 230. If however, the reported time and date is outside the acceptable range 236, the Owner Control Module 30 may instruct the Engine Control Unit 26 to disable the vehicle 242 by shutting off fuel. In an alternative embodiment, the Owner Control Module 30 instructs the External Communication Module 28 to send a message 238 to the owner that the vehicle is operating outside the acceptable range of times and dates. The External Communication Module 28 then waits 246 for a predetermined time for a response by the owner. If the owner does not respond in the allotted time 244, which is tracked by the Owner Control Module 30, the vehicle is disabled 242.

On the other hand, if the vehicle receives the message from the owner that the vehicle is being operated outside the predetermined range of acceptable times and dates, he/she may issue an override command 248 which is received by the External Communication Module 28 and then sent to the Owner Control Module 30. The override command 248 may simply be an instruction to terminate the algorithm 250 or the owner may specify new acceptable times and/or dates 240.

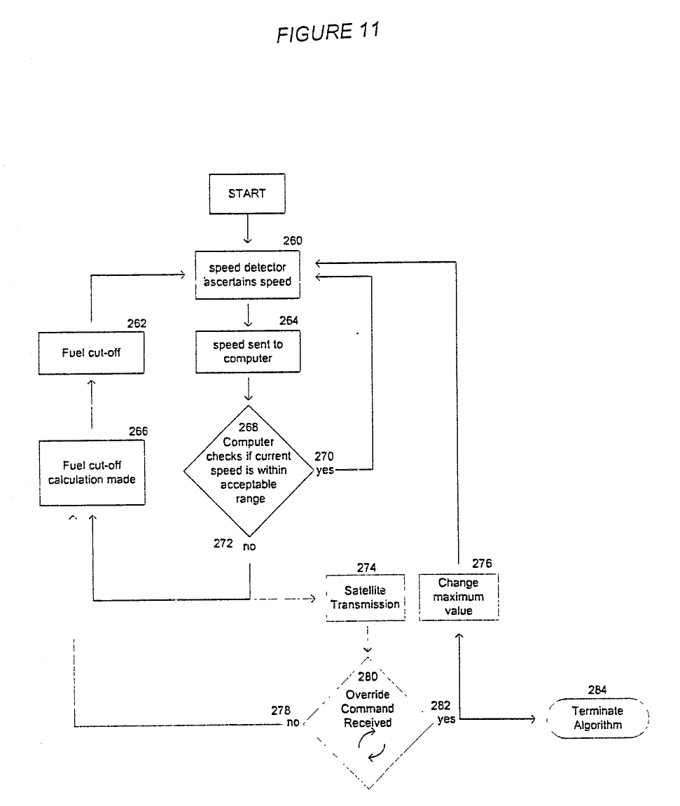

FIG. 11 illustrates, by way of example, an exemplary program the Owner Control Module 30 executes which precludes a operator from driving a vehicle if the traveling speed exceeds a maximum allowable speed. The operator inputs via the Input/Output Interface 34, the maximum allowable speed for driving the vehicle. Also the Owner Control Module 30 may determine the maximum allowable speed by ascertaining the current position of the vehicle through the GPS Module 14 and corresponding the current location with a posted speed limit. The posted speed limit(s) may be stored inside the GPS Module 14 or the Owner Control Module 30 along with the map(s) which allow a vehicle to be located given the latitude, longitude, and altitude reported by the GPS Module.

After the maximum speed is realized, the algorithm begins with the Speed Detector Module 18 ascertaining the current speed 260. This information is then sent 264 to the Owner Control Module 30 via the Communications bus 24. The Owner Control Module 30 checks if the reported speed is less than or equal to the maximum allowable speed 268. If the reported speed is acceptable 270, the algorithm starts over again 260. If however, the reported speed exceeds the acceptable maximum 272, the Owner Control Module 30 may instruct 266 the Engine Control Unit 26 to Cutoff and/or limit Fuel 266, 262 to the engine in such a manner that the vehicle 10 is only able to travel at or below the maximum allowable speed. In one embodiment, the system does not abruptly cutoff fuel to the vehicle but rather controls the fuel for a smooth transition to an acceptable speed. In an alternative embodiment, the Owner Control Module 30 instructs the External Communication Module 28 to send a message 274 to the owner that the vehicle is traveling above an acceptable speed. The External Communication Module 28 then waits 280 for a predetermined time for a response by the owner. If the owner does not respond in the allotted time 278, the Owner Control Module 30 may instruct the Engine Control Unit 26 to Cutoff and/or limit Fuel 266, 262 to the engine.

On the other hand, if the owner receives the message from the vehicle that the vehicle is traveling above the maximum allowable speed, he/she may issue an override command 282 which is received by the External Communication Module 28 and then sent to the Owner Control Module 30. The override command 282 may simply be an instruction to terminate the algorithm 284 or the owner may specify a new maximum allowable speed 276.

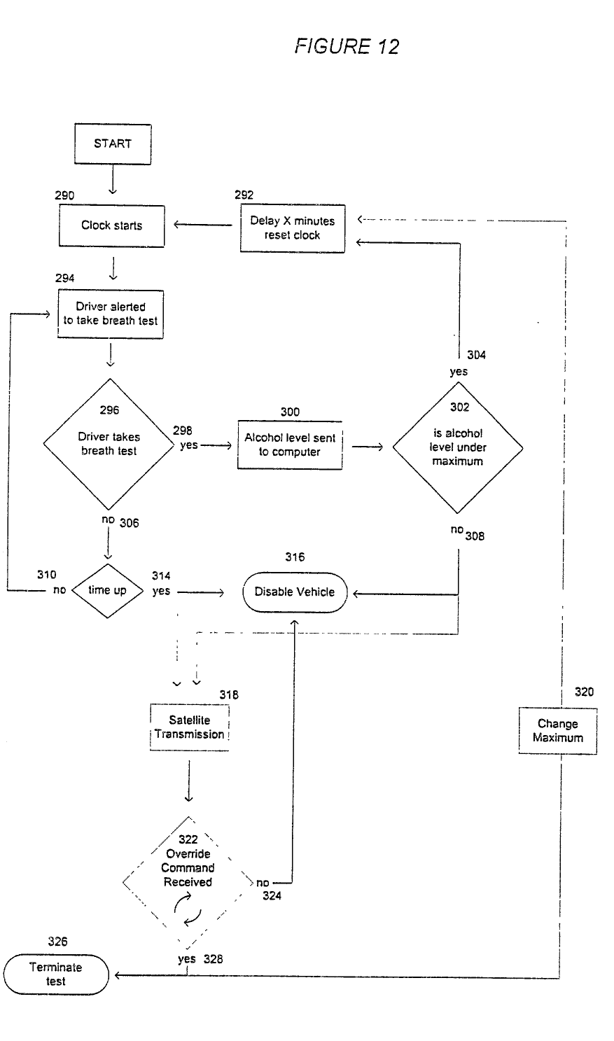

FIG. 12 illustrates, by way of example, an exemplary program the Owner Control Module 30 executes which precludes a operator from driving the vehicle if a Breath Alcohol Module 32 detects the operator has consumed alcohol. The operator inputs via the Input/Output Interface 34, the maximum allowable blood alcohol limit for driving the vehicle. The operator may also specify a zero tolerance setting where any detection of alcohol, however miniscule, will qualify as the maximum allowable blood alcohol limit.

The algorithm begins after the vehicle is started with the initiation of a timer countdown 290. The operator is immediately alerted 294 through an output mechanism that a countdown has initiated and the operator has a certain amount of time to take a breathalizer test before the vehicle will shut down. The actual “time remaining” may be output to the operator via an output mechanism such as an instrument panel display. The output mechanism may also include a flashing light on the instrument panel with an audible warning through speakers. If the operator does not take the breathalizer test 306 and the timer countdown is still running 310, the operator is alerted again through the output mechanism 294. When the timer runs out 314 however, the Owner Control Module 30 alerts the Engine Control Unit 26 to disable the vehicle 316.

If the operator takes the breathalizer test 298 through the breathalizer, the predicted blood alcohol content is ascertained by the Breath Alcohol Module 32. The level is then sent 300 to the Owner Control Module 30 which determines if the level is under the maximum allowable number 302. If the number is under the maximum allowable number 304, a delay is performed for an interval of time specified by the owner 292. For example, the delay may be set at sixty minutes so that after approximately every sixty minutes the operator is alerted to take the breathalizer test. Following the interval delay 292, the timer countdown begins again 290.

In an alternative embodiment, if the blood alcohol content number is greater than or equal to the maximum allowable number 308 or if the time limit to take the test expires 314, the Owner Control Module 30 instructs the External Communication Module 28 to send a message 318 to the owner that the operator of the vehicle is driving with a particular blood alcohol level. The External Communication Module 28 then waits 322 for a predetermined time for a response by the owner. If the owner does not respond in the allotted time 324, the Owner Control Module 30 may instruct the Engine Control Unit 26 to disable the vehicle 316. On the other hand, if the owner receives the message from the vehicle that the operator has a particular blood alcohol content level, he/she may issue an override command which is received 328 by the External Communication Module 28 and then sent to the Owner Control Module 30. The override command may simply be an instruction to terminate the algorithm 326 or the owner may specify a new maximum allowable blood alcohol content level 320.

The system and methods described above in FIGS. 1-12 for vehicle control systems, are for exemplary purposes only and many variations are contemplated. Any systems and/or methods involving vehicle operation conditions such as allowable areas of travel, acceptable times and dates of vehicle operation, permissible occupant loads, permissible vehicle speeds, and operator alcohol consumption, are within the scope of the present invention. All of the methods described above may be implemented in software, hardware, and/or a combination of both.

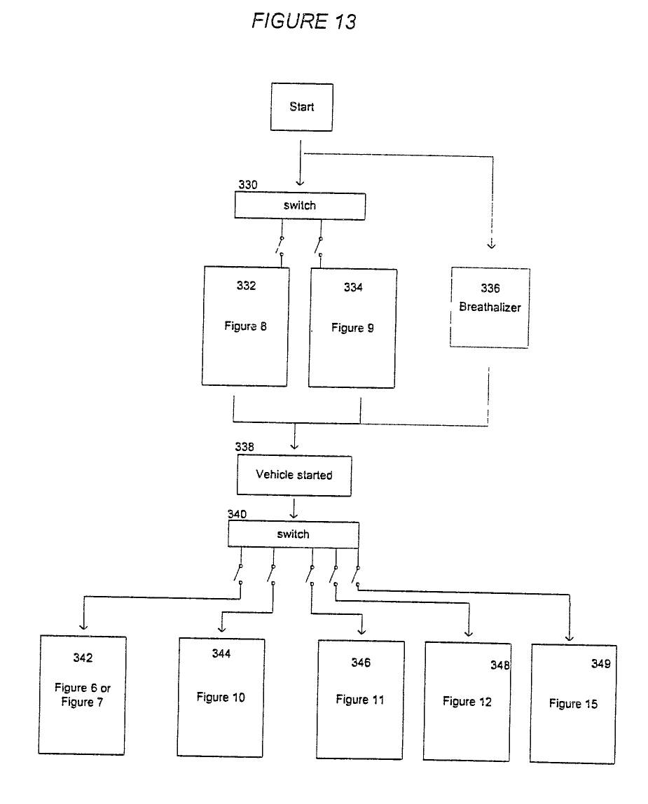

The invention applies to all types of combinations and/or rearrangements of the methods and systems described. For example, FIG. 13 shows one exemplary implementation of all of the systems described above. The switch 330 allows the methods, described in FIG. 8 and FIG. 9, which pertain to starting the vehicle, to be implemented. The switch 340 allows the methods, described in FIGS. 6, 7, 10, 11, 12, and 15, which pertain to a vehicle which has already been started, to be implemented.

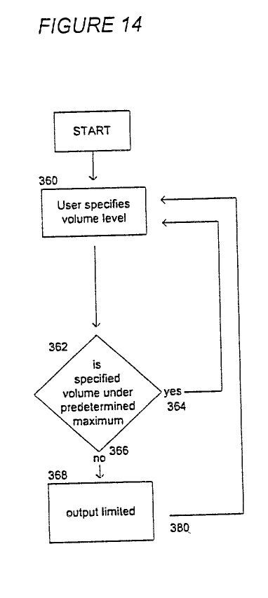

FIG. 14 illustrates by way of example an alternative embodiment of the present invention where a predetermined maximum allowable volume limits the audio output in a vehicle audio system. Components of a vehicle audio system may include, but are not limited to, audio amplifiers, power supplies, CD players, cassette players, digital and analog radio receivers, equalizers, pre amplifiers, etc. After a user specifies a desired volume level 360, a conditional check 362 determines if the specified volume is under the predetermined maximum. The conditional check 362 may be programmed directly into any component of the vehicle audio system (not shown), the Owner Control Module 30, and/or an Audio Control Module 36. The conditional check 362 may be implemented in software, hardware, and/or may be a simple electrical limiter which restricts the audio output to a predetermined maximum. If the user specified volume is under the predetermined maximum 364, the volume is set and the algorithm repeats when the user specifies another volume level 360. If, however, the user specified volume exceeds the predetermined maximum 366, the output is limited 368 to the predetermined maximum and the algorithm repeats when the user specifies another volume level.

It is to be understood that the process outlined in FIG. 14 is for exemplary purposes only and intended to illustrate a broad method of limiting volume. For example, the check 362 may actually be an electrical circuit which saturates the output to a level specified by the vehicle owner regardless of what the operator specifies.

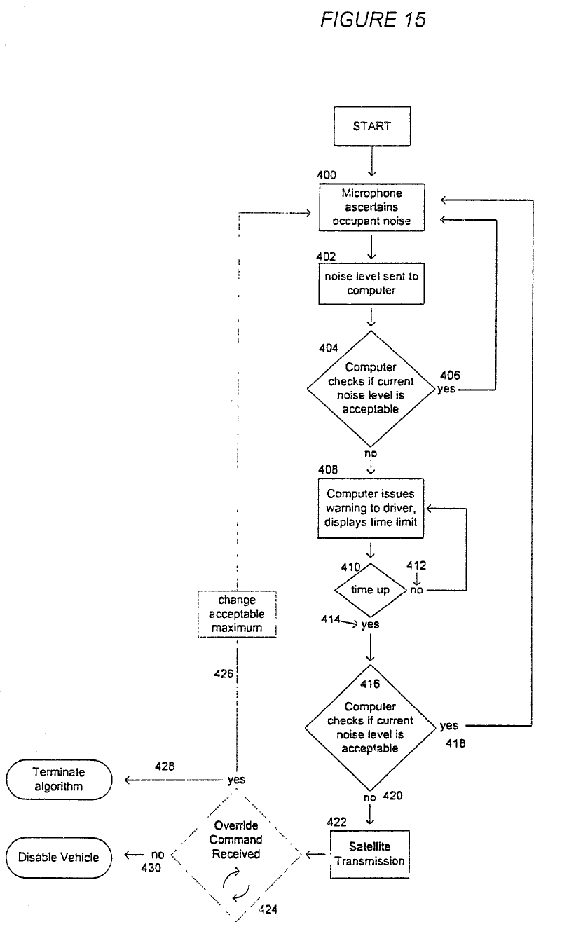

FIG. 15 illustrates, by way of example, an exemplary method of the present invention where the Owner Control Module 30 and/or the Audio Control Module 36 executes a program which precludes an operator from driving if the noise level inside the vehicle exceeds a predetermine maximum allowable noise. The program may be implemented as a software algorithm utilizing the Owner Control Module 30 and/or the Audio Control Module 36 microprocessor and local memory. First, the owner inputs via the Input/Output Interface 34, the permissible noise level.

After a predetermined maximum noise level is specified, the algorithm begins with the Audio Control Module 36 ascertaining the current noise level inside the vehicle 400. A microphone (not shown) may be communicatively coupled to the Audio Control Module 36. The current noise level is then sent 402 to the Owner Control Module 30 via the communication bus 24. The Owner Control Module 30 checks 404 if the reported noise level is less than a predetermined maximum allowable noise level. If the reported noise level is acceptable, 406, the algorithm begins again 400.

On the other hand, if the Owner Control Module 30 determines the noise level inside the vehicle is not under the predetermined maximum, the Owner Control Module 30 issues a warning 408 to the operator, and initiates a time countdown. The warning repeats for the duration of the time countdown 410, 412, 408. The operator of the vehicle can use the time before the time expires to bring the noise level inside the vehicle to an acceptable level. When the timer expires 414, the current noise level is ascertained and the computer again checks if the noise level is under the predetermined maximum allowable noise level 416. If the noise level is within the acceptable level 418, the algorithm begins again 400. If however, the reported noise level exceeds the maximum allowable level 414, the Owner Control Module 30 may instruct the Engine Control Unit 26 to disable 430 the vehicle. In an alternative embodiment, the Owner Control Module 30 instructs the External Communication Module 28 to send a message 422 to the owner that the current noise level in the vehicle exceeds the allowable level. The External Communication 28 module then waits 424 for a predetermined time for a response by the owner. If the owner does not respond in the allotted time 430, which is tracked by the Owner Control Module 30, the fuel is limited or even shut off.

On the other hand, if the owner receives the message from the vehicle that the current noise level within the vehicle exceeds the maximum allowable level, he/she may issue an override command which is received by the External Communication Module 28 and then sent to the Owner Control Module 30. The override command may simply be an instruction to terminate the algorithm 428 or the owner may specify a new acceptable noise level 426.

The invention applies to all types of vehicle control modules known to one ordinarily skilled in the art, such as, but not limited to, Instrument Panel Modules, Brake System Modules, Safety System Modules. All figures described herein are for exemplary purposes only and are not drawn to scale. The present invention applies to all vehicles such as automobiles, boats, motorcycles etc.

Although the invention is described above utilizing control modules and/or a communications bus of a computer controlled vehicle, it is within the scope of the present invention to utilize a vehicle without a communications bus and/or individual control modules. In this alternative embodiment, the present invention would be adapted to control the independent electrical and/or mechanical systems of a vehicle through a central control computer.

In closing, it is noted that specific illustrative embodiments of the invention have been disclosed hereinabove. However, it is to be understood that the invention is not limited to these specific embodiments. With respect to the claims, it is the applicant's intention that the claims not be interpreted in accordance with the sixth paragraph of 35 U.S.C. § 112 unless the term “means” is used followed by a functional statement.

What is claimed is:

1. A vehicle control system, comprising:
a global positioning system (GPS) receiver; and
a computer communicatively coupled to the GPS receiver wherein the GPS receiver communicates a current position to the computer;
the computer adapted to communicate with an engine control unit of a vehicle and if the position of the vehicle as determined by the GPS receiver is outside of a predetermined area, the computer instructs the engine control unit to disable the vehicle.

2. A vehicle control system according to claim 1 wherein the computer communicates with a third party if the vehicle is outside of the predetermined area to inform the third party that the vehicle is outside of the predetermined area.

3. A vehicle control system according to claim 2 where the third party communicates with the computer to disable the vehicle.

4. A vehicle control system according to claim 2 where the third party communicates with the computer to continue operation of the vehicle.

5. A vehicle control system, comprising:
an occupant sensor;
a computer communicatively coupled to the occupant sensor wherein the occupant sensor communicates a number of passengers to the computer;
the computer adapted to communicate with an ignition system of a vehicle and, if the number of passengers in the vehicle as determined by the occupant sensor is less than a predetermined number, the computer permits ignition of the vehicle.

6. The vehicle control system according to claim 5 wherein the occupant sensor is an infrared sensor.

7. The vehicle control system according to claim 5 wherein the occupant sensor is a pressure sensor.

8. A vehicle control system, comprising:
a clock;
a computer communicatively coupled to the clock wherein the clock communicates a time and a date to the computer;
the computer adapted to communicate with an ignition system of a vehicle and if the time and the date as determined by the clock are not within a predetermined range, the computer instructs the ignition system to prevent ignition of the vehicle.

9. A vehicle control system, comprising:
a clock;
a computer communicatively coupled to the clock wherein the clock communicates a time and a date to the computer;
the computer adapted to communicate with an engine control unit of a vehicle and, if the time and the date as determined by the clock are not within a predetermined range of times and dates, the computer instructs the engine control unit to disable the vehicle.

10. A vehicle control system according to claim 9 wherein the computer communicates with a third party if the time and the date are not within the predetermined range of times and dates to inform the third party that the time and the date are not within the predetermined range of times and dates.

11. A vehicle control system according to claim 10 where the third party communicates with the computer to disable the vehicle.

12. A vehicle control system according to claim 10 where the third party communicates with the computer to continue operation of the vehicle.

13. A vehicle control system, comprising:
a speed detector;
a computer communicatively coupled to the speed detector wherein the speed detector communicates a current speed to the computer;
the computer adapted to communicate with an engine control unit of a vehicle and, if the current speed as determined by the speed detector exceeds a predetermined speed, the computer instructs the engine control unit to limit fuel so that the current speed does not exceed the predetermined speed.

14. A vehicle control system according to claim 13 wherein the computer communicates with a third party if the current speed exceeds the predetermined speed to inform the third party that the current speed exceeds the predetermined speed.

15. A vehicle control system according to claim 14 where the third party communicates with the computer to disable the vehicle.

16. A vehicle control system according to claim 14 where the third party communicates with the computer to continue operation of the vehicle.

17. The vehicle control system according to claim 13 wherein the speed detector is a speedometer.

18. A vehicle control system comprising
a breath alcohol measuring device;
a computer communicatively coupled to the breath alcohol measuring device wherein the breath alcohol measuring device communicates an alcohol consumption level to the computer;
the computer adapted to communicate with an engine control unit of a vehicle and, if the alcohol consumption level as determined by the breath alcohol measuring device exceeds a predetermined level, the computer instructs the engine control unit to disable the vehicle.

19. A vehicle control system according to claim 18 wherein the computer communicates with a third party if the alcohol consumption level exceeds the predetermined level to inform the third party that the alcohol consumption level exceeds the predetermined level.

20. A vehicle control system according to claim 19 where the third party communicates with the computer to disable the vehicle.

21. A vehicle control system according to claim 19 where the third party communicates with the computer to continue operation of the vehicle.

22. A method for controlling a vehicle, comprising:
ascertaining a position of a vehicle with a location device;
instructing an engine control unit of the vehicle to disable the vehicle if the position is outside a predetermined range.

23. A method for controlling a vehicle according to claim 22 wherein the location device is a GPS device.

24. A method for controlling a vehicle, comprising:
ascertaining a speed of a vehicle;
instructing an engine control unit of the vehicle to limit fuel to the vehicle if the speed exceeds a predetermined speed.

25. A method for controlling a vehicle, comprising:
ascertaining a number of passengers in a vehicle;
instructing an ignition system of the vehicle to prevent ignition of the vehicle if the number of passengers exceeds a predetermined number of passengers.

26. A method for controlling a vehicle, comprising:
ascertaining a time and a date;
instructing an ignition system of a vehicle to prevent ignition of the vehicle if the time and the date are outside a predetermined range.

27. A method for controlling a vehicle, comprising:
ascertaining an alcohol consumption level;
instructing an engine control unit of a vehicle to disable the vehicle if the alcohol consumption level exceeds a predetermined alcohol consumption level.

28. A method for controlling a vehicle, comprising:
ascertaining a position of a vehicle;
ascertaining a speed of the vehicle;
ascertaining a number of passengers in the vehicle;
ascertaining a time and a date;
instructing a fuel system of the vehicle to limit fuel to the vehicle if the position is outside a predetermined range;
instructing the fuel system of the vehicle to limit fuel to the vehicle if the speed exceeds a predetermined speed;
instructing an ignition system of the vehicle to prevent ignition of the vehicle if the number of passengers exceeds a predetermined number of passengers;
instructing an ignition system of the vehicle to prevent ignition of the vehicle if the time and the date are outside a predetermined range.

29. A method according to claim 28 further comprising:
instructing a fuel system of the vehicle to limit fuel to the vehicle if the time and the date are outside a predetermined range.

30. A vehicle audio control system, comprising
an audio system;
the audio system adapted to limit an output level if a user specified output level exceeds a predetermined maximum allowable output level.

31. A vehicle control system comprising
a sound level detector;
a computer communicatively coupled to the sound level detector wherein the sound level detector communicates a current sound level to the computer;
the computer adapted to communicate with an engine control unit of a vehicle and, if the current sound level determined by the sound level detector exceeds a predetermined sound level, the computer instructs the engine control unit to disable the vehicle.

32. A vehicle control system according to claim 31 wherein the computer communicates with a third party if the current sound level exceeds the predetermined sound level to inform the third party that the current sound level exceeds the predetermined sound level.

33. A vehicle control system according to claim 32 where the third party communicates with the computer to disable the vehicle.

34. A vehicle control system according to claim 32 where the third party communicates with the computer to continue operation of the vehicle.

35. A method for controlling a vehicle comprising:
ascertaining a sound level;
instructing the fuel system of the vehicle to limit fuel to the vehicle if the sound level exceeds a predetermined sound level.
